(19) United States
(12) Patent Application Publication
(10) Pub. No.: US 2016/0293947 A1
(43) Pub. Date: Oct. 6, 2016

(54) SOLID-ELECTROLYTE PRECURSOR, MANUFACTURING METHOD THEREFOR, METHOD FOR MANUFACTURING SOLID ELECTROLYTE, AND METHOD FOR MANUFACTURING SOLID-ELECTROLYTE/ELECTRODE-ACTIVE-MATERIAL COMPLEX

(71) Applicant: CENTRAL GLASS CO., LTD., Ube-shi, Yamaguchi (JP)

(72) Inventors: Tetsuya TAMURA, Ube-shi, Yamaguchi (JP); Ryota ESAKI, Ube-shi, Yamaguchi (JP); Tsutomu NISHIZAKI, Ube-shi, Yamaguchi (JP)

(21) Appl. No.: 15/032,432

(22) PCT Filed: Oct. 14, 2014
(86) PCT No.: PCT/JP2014/077297

§ 371 Date: Apr. 27, 2016

(30) Foreign Application Priority Data
Nov. 1, 2013 (JP) 2013-228422

(51) Int. Cl. H01M 4/485; H01M 10/0525; H01M 10/0562; H01M 4/1391; H01M 4/131

(52) U.S. Cl. CPC H01M 4/485; H01M 4/1391; H01M 4/131; H01M 10/0562; H01M 10/0525; H01M 2300/0071

(57) ABSTRACT

This invention provides the following: a solid-electrolyte precursor that yields a solid electrolyte when fired at a temperature lower than the firing temperatures used in solid phase methods and has a low mass reduction rate when thus fired; a method for manufacturing said solid-electrolyte precursor; a method for manufacturing a solid electrolyte; and a method for manufacturing a solid-electrolyte/electrode-active-material complex. This solid-electrolyte precursor, which is fired at a temperature less than or equal to 1,000° C. in order to synthesize a solid electrolyte that has a single-phase perovskite structure or a single-phase garnet structure and contains lithium, a group 3 element, and a group 4 element and/or a group 5 element, contains lithium, an oxide and/or hydroxide of a group 3 element, and an oxide and/or hydroxide of a group 4 element and/or a group 5 element.

### TECHNICAL FIELD

The present invention relates to a solid-electrolyte precursor, its method of manufacture, a method of manufacturing a solid electrolyte, and a method of manufacturing a solid-electrolyte/electrode-active-material complex.

### BACKGROUND ART

All-solid batteries and lithium air batteries are considered to be promising, in particular for use in automobiles, as next-generation secondary batteries. With the objective of the application of these batteries, the development of oxide-based lithium ion-conductive solid electrolytes has proceeded.

As synthesis methods of solid electrolytes mainly, solid phase methods, and liquid phase methods centered on sol-gel methods are known.

A solid phase method is a synthesis method where, for example oxides, hydroxides, and/or salts of each of a group 3 element, a group 4 or group 5 element, and lithium are mixed in approximately stoichiometric ratios, fired and sintered.

A sol-gel method is a method of synthesizing a solid electrolyte, for example by first preparing a mixed solution (sol) of a group 3 element, a group 4 or group 5 element, and lithium to attain a mixed state of these elements which is uniform at the atomic level, and next, heat-concentrating this mixed solution (sol) to gel, whereby a solid state precursor (gel) is formed, and finally, firing this gel. A sol-gel method is a method whereby it is possible to achieve synthesis of a solid electrolyte at a lower temperature than the solid phase method, by going through a precursor (gel) uniformly comprising an approximate stoichiometric ratio of a group 3 element, a group 4 or group 5 element, and lithium.

For example, Patent Document 1 discloses a method of preparing a precursor solution in which each element is uniformly mixed, using acetates as an La source and Li source, titanium tetraisopropoxide (TTIP) as a titanium source, and a mixture of 2-propanol and water as a solvent, and optimizing the addition of a polyvinylpyrrolidone thickener and the mixing order sequence. Patent Document 2 discloses a method of preparing a precursor solution in which each element is uniformly mixed, by using an acetate as an La source, a carbonate as an Li source, a lactate aqueous solution as a Ti source, and water as a solvent. Patent Document 3 discloses a method of preparing a precursor solution in which each element is uniformly mixed, by using acetates as an La source and Li source, a lactate aqueous solution as a Ti source, and a mixture of 2-propanol and water as a solvent, and adding polyethylene oxide as a thickener.

Patent Document 1: Japanese Unexamined Patent Application, Publication No. 2010-165527

Patent Document 2: PCT International Publication No. WO2009/157524

Patent Document 3: Japanese Unexamined Patent Application, Publication No. 2003-346895

### DISCLOSURE OF THE INVENTION

### Problems to be Solved by the Invention

In the solid phase method, because the uniformity of the mixture of each of the raw materials is low, it is necessary to fire at a high temperature of 1150° C. or more in order to obtain a single phase solid electrolyte. However, when carrying out firing at such high temperatures, it is difficult to attain energy savings and low environmental impact, and in addition, lithium is readily volatilized. Further, when complexing a solid electrolyte and a material having a lower thermal stability than the solid electrolyte, the solid phase method is not necessarily a superior method. For example, in an all-solid battery, from the viewpoint of lithium ion conductivity, in a solid-electrolyte/electrode-active-material complex, it is essential for the electrode phase and the solid electrolyte phase to be in close contact, but if it is attempted to obtain the above mentioned complex by firing at a temperature exceeding 1000° C., because the electrode active material is readily decomposed at such high temperatures, in some cases it is difficult to complex the electrode phase and the solid electrolyte phase by the solid phase method. Further, in the solid phase method, coarse amorphous portions readily occur in the product, and also in the point that the monodispersity of the grain size is low, it is difficult to complex with other materials.

In the sol-gel method, in order to overcome the flaws of the solid phase method, first, a group 4 or group 5 element component is stabilized in a dissolved state using an organic ligand, and after a precursor (gel) which is a solid phase has been deposited by solvent distillation, the precursor (gel) is fired at a lower temperature than the firing temperature of the solid phase method, to obtain the final product. In this process, elimination of the organic ligand and the like occurs, whereby the problem of high mass reduction rate arises.

The present invention was made in consideration of this state of the prior art, and has the objective of providing a solid-electrolyte precursor which can yield a solid electrolyte by firing at a lower temperature than the firing temperature of the solid phase method and which has a low mass reduction rate when firing, its method of manufacture, a method of manufacturing a solid electrolyte, and a manufacturing method of a solid-electrolyte/electrode-active-material complex.

### Means for Solving the Problems

The present inventors carried out repeated diligent research in order to achieve the above objectives. As a result, it was discovered that the above mentioned objectives can be achieved by a solid-electrolyte precursor comprising lithium, an oxide and/or hydroxide of a group 3 element, and an oxide and/or hydroxide of a group 4 and/or group 5 element, and it was further discovered that such a solid-electrolyte precursor can be manufactured by simultaneously precipitating an oxide and/or hydroxide of a group 3 element, and an oxide and/or hydroxide of a group 4 and/or group 5 element, and mixing the obtained precipitate with a lithium compound, whereby the present invention was completed. Specifically, the present invention provides the following.

The first aspect of the present invention is a solid-electrolyte precursor for synthesis, by firing at a temperature of 1000° C. or less, of a solid electrolyte which comprises lithium, a group 3 element, and a group 4 and/or group 5 element and which has a single phase perovskite structure or a single phase garnet structure; the solid-electrolyte precursor comprising: lithium, an oxide and/or hydroxide of a group 3 element, and an oxide and/or hydroxide of a group 4 and/or group 5 element.

The second aspect of the present invention is a method of manufacturing a solid electrolyte, comprising a firing step of obtaining a solid electrolyte by firing the above mentioned solid-electrolyte precursor at a temperature of 1000° C. or less.

The third aspect of the present invention is a method of manufacturing a solid-electrolyte/electrode-active-material complex, comprising a contacting step of contacting the above mentioned solid-electrolyte precursor and an electrode active material or an electrode active material precursor which becomes an electrode active material by firing, and a firing step of obtaining a solid-electrolyte/electrode-active-material complex by firing the above mentioned solid-electrolyte precursor and the above mentioned electrode active material or the above mentioned electrode active material precursor at a temperature of 1000° C. or less.

The fourth aspect of the present invention is a method of manufacturing a solid-electrolyte precursor for synthesis, by firing at a temperature of 1000° C. or less, of a solid electrolyte which comprises lithium, a group 3 element, and a group 4 and/or group 5 element and which has a single phase perovskite structure or a single phase garnet structure; the method comprising: an aqueous solution preparation step of preparing an aqueous solution comprising a group 3 element-containing cation, and a group 4 element-containing cation and/or a group 5 element-containing cation, a simultaneous precipitation processing step of obtaining a precipitate by mixing the aqueous solution obtained in the above mentioned aqueous solution preparation step and a basic aqueous solution to precipitate an oxide and/or hydroxide of a group 3 element, and an oxide and/or hydroxide of a group 4 and/or group 5 element, and a solid-electrolyte precursor producing step of obtaining a solid-electrolyte precursor by mixing the precipitate obtained in the above mentioned simultaneous precipitation processing step and a lithium compound.

The fifth aspect of the present invention is a method of manufacturing a solid electrolyte comprising: an aqueous solution preparation step of preparing an aqueous solution comprising a group 3 element-containing cation, and a group 4 element-containing cation and/or a group 5 element-containing cation, a simultaneous precipitation processing step of obtaining a precipitate by mixing the aqueous solution obtained in the above mentioned aqueous solution preparation step and a basic aqueous solution to precipitate an oxide and/or hydroxide of a group 3 element, and an oxide and/or hydroxide of a group 4 and/or group 5 element, a solid-electrolyte precursor producing step of obtaining a solid-electrolyte precursor by mixing the precipitate obtained in the above mentioned simultaneous precipitation processing step and a lithium compound, and a firing step of obtaining a solid electrolyte by firing the solid-electrolyte precursor obtained in the above mentioned solid-electrolyte precursor producing step at a temperature of 1000° C. or less.

The sixth aspect of the present invention is a method of manufacturing a solid-electrolyte/electrode-active-material complex comprising: an aqueous solution preparation step of preparing an aqueous solution comprising a group 3 element-containing cation, and a group 4 element-containing cation and/or a group 5 element-containing cation, a simultaneous precipitation processing step of obtaining a precipitate by mixing the aqueous solution obtained in the above mentioned aqueous solution preparation step and a basic aqueous solution to precipitate an oxide and/or hydroxide of a group 3 element, and an oxide and/or hydroxide of a group 4 and/or group 5 element, a solid-electrolyte precursor producing step of obtaining a solid-electrolyte precursor by mixing the precipitate obtained in the above mentioned simultaneous precipitation processing step and a lithium compound, a contacting step of contacting the solid-electrolyte precursor obtained in the above mentioned solid-electrolyte precursor producing step and an electrode active material or an electrode active material precursor which becomes an electrode active material by firing, and a firing step of obtaining a solid-electrolyte/electrode-active-material complex by firing the above mentioned solid-electrolyte precursor and the above mentioned electrode active material or the above mentioned electrode active material precursor at a temperature of 1000° C. or less.

### Effects of the Invention

According to the present invention, it is possible to provide a solid-electrolyte precursor which can yield a solid electrolyte by firing at a lower temperature than the firing temperature of the solid phase method and which has a low mass reduction rate when performing the above mentioned firing, its method of manufacture, a method of manufacture of a solid electrolyte, and a method of manufacture of a solid-electrolyte/electrode-active-material complex.

### PREFERRED MODE FOR CARRYING OUT THE INVENTION

### Solid-Electrolyte Precursor

The solid-electrolyte precursor according to the present invention is one for synthesizing, by firing at a temperature of 1000° C. or less, a solid electrolyte which comprises lithium, a group 3 element, and a group 4 and/or group 5 element and which has a single phase perovskite structure or a single phase garnet structure; the solid-electrolyte precursor comprising lithium, an oxide and/or hydroxide of a group 3 element, and an oxide and/or hydroxide of a group 4 and/or group 5 element. The solid electrolyte synthesized from the solid-electrolyte precursor according to the present invention is an oxide-based lithium ion-conductive solid electrolyte, and specifically, solid electrolytes having a perovskite structure such as LLTO (Li3xLa2/3-xTiO3) and the like, and solid electrolytes having a garnet structure such as LLZO (Li7La3Zr2O12), LLZNb (Li6.75La3Zr1.75Nb0.25O12), Li5La3M2O12 (M=Nb, Ta) and the like may be mentioned.

From the solid-electrolyte precursor according to the present invention, it is possible to synthesize a solid electrolyte which comprises lithium, a group 3 element, and a group 4 and/or group 5 element and which has a single phase perovskite structure or a single phase garnet structure, by firing at a temperature of 1000° C. or less, which is lower than the firing temperature of the solid phase method (normally 1150° C. or more), and preferably at a temperature of 600° C. to 1000° C. (below referred to as “low temperature firing”). In the low temperature firing, reduction of the lithium content due to volatilization does not readily occur, and in the synthesized solid electrolyte, it is easy to maintain uniformity of the composition. Further, a solid electrolyte synthesized by low temperature firing of the solid-electrolyte precursor according to the present invention has a high uniformity of form compared to a solid electrolyte obtained by the solid phase method, for example, particles with a matched grain size can be obtained.

Further, the solid-electrolyte precursor according to the present invention comprises a group 3 element and a group 4 and/or group 5 element in the form of an oxide and/or hydroxide, whereby it is possible to reduce the content of organic substances (the main components which are eliminated when firing), and therefore, the mass reduction rate upon low temperature firing can easily be made low. Generally, in order to increase the lithium ion conductivity, it is very important that the solid electrolytes contact each other, and in the case of complexing a solid electrolyte and an electrode active material, it is very important that the solid electrolyte and the electrode active material contact each other, and therefore, it is preferable for the obtained solid electrolyte to be more compact. By using a solid-electrolyte precursor with few components which are eliminated when low temperature firing, i.e., having a lower mass reduction rate when low temperature firing, it is easy to obtain a more compact solid electrolyte. The mass reduction rate when low temperature firing the solid-electrolyte precursor according to the present invention can easily be made low, therefore, the lithium ion conductivity of the solid electrolyte obtained from this solid-electrolyte precursor can easily be increased, and further, cracks do not readily occur, and therefore, the yield rate can easily be increased.

In the solid-electrolyte precursor according to the present invention, and in the solid electrolyte synthesized from this solid-electrolyte precursor, each of the group 3 element, the group 4 element, and the group 5 element may be used singly or may be used in combinations of two or more. Herein, the group 3 element means at least one selected from the group consisting of Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, and Lr, and is preferably at least one selected from the group consisting of Y, La, Ce, Pr, Nd, Sm, Eu, and Gd, more preferably at least one selected from the group consisting of Y, La, and Ce, and even more preferably La. Further, the group 4 and/or group 5 element means at least one selected from the group consisting of Ti, Zr, Hf, Rf, V, Nb, Ta, and Db, and is preferably at least one selected from the group consisting of Ti, Zr, V, Nb, and Ta, more preferably at least one selected from the group consisting of Ti, Zr, Nb, and Ta, and even more preferably Ti or Zr.

The total content of carbon and nitrogen in the solid-electrolyte precursor according to the present invention is preferably 10 mass % or less, more preferably 8 mass % or less, and even more preferably 5 mass % or less. If the above mentioned total content is 10 mass % or less, when obtaining a solid electrolyte by low temperature firing the solid-electrolyte precursor according to the present invention, the mass reduction rate can easily be made low.

When obtaining a solid electrolyte by firing the solid-electrolyte precursor according to the present invention at a temperature of 1000° C. or less (for example, 600 to 1000° C.), the mass reduction rate calculated by the following formula:

mass reduction rate (mass %)=(mass of the solid-electrolyte precursor−mass of the solid electrolyte)×100/mass of the solid-electrolyte precursor

is preferably 40 mass % or less. If the above mass reduction rate is 40 mass % or less, the obtained solid electrolyte will more readily become compact, and therefore, the lithium ion conductivity can be further increased, and cracking will even less readily occur, and therefore, the yield can easily be further increased.

In the solid-electrolyte precursor according to the present invention, the composition ratio of the lithium, group 3 element, and group 4 and/or group 5 element can be suitably selected based on the composition ratio of these elements in the target solid electrolyte. In the case of low temperature firing the solid-electrolyte precursor according to the present invention, a reduction of the lithium content does not readily occur, and the composition ratio of the above mentioned elements in the obtained solid electrolyte can be easily made to resemble the composition ratio of the above mentioned elements in the above solid-electrolyte precursor.

The solid-electrolyte precursor according to the present invention may be one obtained by any production method, but, for example, it is preferably one obtained by the manufacturing methods described later. Further, the form of the solid-electrolyte precursor according to the present invention is not particularly limited, and may be in a solid state, a solution such as an aqueous solution, or a slurry.

### Method of Manufacturing the Solid-Electrolyte Precursor

The method of manufacturing the solid-electrolyte precursor according to the present invention is a method of manufacturing a solid-electrolyte precursor for synthesis, by firing at a temperature of 1000° C. or less, of a solid electrolyte which comprises lithium, a group 3 element, and a group 4 and/or group 5 element and which has a single-phase perovskite structure or a single-phase garnet structure, the method comprising: an aqueous solution preparation step of preparing an aqueous solution comprising a group 3 element-containing cation, and a group 4 element-containing cation and/or a group 5 element-containing cation, a simultaneous precipitation processing step of obtaining a precipitate by mixing the aqueous solution obtained in the above mentioned aqueous solution preparation step and a basic aqueous solution to precipitate an oxide and/or hydroxide of a group 3 element, and an oxide and/or hydroxide of a group 4 and/or group 5 element, and a solid-electrolyte precursor producing step of obtaining a solid-electrolyte precursor by mixing the above mentioned precipitate obtained in the above mentioned simultaneous precipitation processing step and a lithium compound. The above mentioned manufacturing method is one for obtaining a solid-electrolyte precursor by applying a liquid phase synthesis method. The advantage of adopting a liquid phase synthesis method is the point that, by passing through a mixed solution state, it is possible to uniformly mix at an atomic level the metal elements and the like constituting the solid-electrolyte precursor.

The sol-gel method has in common with the above mentioned manufacturing method of the present invention the point of adopting the liquid phase synthesis method. In the sol-gel method, a group 4 or group 5 element component is stabilized in a dissolved state using an organic ligand, and after precipitating a precursor (gel) which is a solid phase by solvent distillation by heating, a solid electrolyte is obtained from this precursor (gel) by low temperature firing. As described above, in the sol-gel method, there is the problem that in the process of the low temperature firing, the mass reduction rate accompanying the elimination of the organic ligand and the like is large.

Further, the raw materials used in the sol-gel method such as the hydroxycarboxylate of titanium used in Patent Documents 2 and 3, generally have long synthesis processes, therefore it is difficult to reduce raw material costs.

Further, in the sol-gel method, it is difficult to select a group 4 or group 5 element source which is soluble. Inorganic salts of group 4 or group 5 elements can only be dissolved in an aqueous solution under strong acidity, and when heat-concentrating, these readily precipitate individually as oxides or the like, and therefore, are difficult to use in the sol-gel method. Further, in the sol-gel method, alkoxides of titanium tetraisopropoxide (TTIP) or the like generally used as the group 4 or group 5 element sources readily undergo hydrolysis, which becomes a problem.

The present inventors focused on the above described problems of the sol-gel method, in particular, the problem of the large mass reduction rate accompanying the low temperature firing, and as a method of manufacturing a precursor having few components which are eliminated by firing (organic components such as organic ligands and the like), studied a method of precipitating from solution a precursor comprising lithium, an oxide and/or hydroxide of a group 3 element, and an oxide and/or hydroxide of a group 4 and/or group 5 element. However, in the case of dissolving a lithium compound, a group 3 element-containing compound, and a group 4 element-containing compound and/or a group 5 element-containing compound in a solvent to obtain a solution, and attempting to obtain from this solution a precipitate comprising lithium, an oxide and/or hydroxide of a group 3 element, and an oxide and/or hydroxide of a group 4 and/or group 5 element, the oxide and/or hydroxide of the group 4 and/or group 5 element precipitates readily, whereas lithium compounds have high solubility and do not readily precipitate as a precipitate, and therefore it is difficult to simultaneously precipitate a lithium compound and an oxide and/or hydroxide of a group 3 element, and an oxide and/or hydroxide of a group 4 and/or group 5 element. As a result of study, it became clear that what must be uniformly mixed at the atomic level in the precursor stage is the oxide and/or hydroxide of the group 3 element, and the oxide and/or hydroxide of the group 4 and/or group 5 element, and even if the lithium component is mixed later with the precipitate of the oxide and/or hydroxide of the group 3 element, and the oxide and/or hydroxide of the group 4 and/or group 5 element, this does not hinder obtaining a uniform solid electrolyte by low temperature firing. Further, it also became clear that it is possible to adopt a simultaneous precipitation method as a method of obtaining a precipitate where the oxide and/or hydroxide of the group 3 element, and the oxide and/or hydroxide of group 4 or group 5 element are uniformly mixed.

According to the manufacturing method of the solid-electrolyte precursor according to the present invention, it is possible to obtain a solid-electrolyte precursor with a low mass reduction rate when firing. Further, in the above mentioned manufacturing method, it is possible to utilize readily acquired and lower cost raw materials. Furthermore, in the above mentioned manufacturing method, it is possible to use raw materials which do not readily decompose, under more stable conditions.

Below, each step included in the method of manufacturing the solid-electrolyte precursor according to the present invention will be explained in detail.

### Aqueous Solution Preparation Step

In the aqueous solution preparation step, an aqueous solution comprising a group 3 element-containing cation, and a group 4 element-containing cation and/or a group 5 element-containing cation is prepared. As the group 3 element-containing cation, for example, a group 3 element cation such as La3+ and the like may be mentioned. As the group 4 element-containing cation, for example, group 4 element cations such as Ti4+, Zr4+ and the like may be mentioned. As the group 5 element-containing cation, for example, group 5 element cations such as Nb5+ and Ta5+ and the like may be mentioned. Each of the group 3 element-containing cation, the group 4 element-containing cation, and the group 5 element-containing cation may be used individually or may be used in combinations of 2 or more. Further, each of the group 3 element-containing cation, the group 4 element-containing cation, and the group 5 element-containing cation may be in the form of a complex with water, ammonia, oxide ions, hydroxide ions, or the later described counter-anions as ligands.

In the above described aqueous solution, as the counter-anions of the group 3 element-containing cation, the group 4 element-containing cation, and the group 5 element-containing cation, besides oxide ions and hydroxide ions, for example, chlorine-containing anions such as chloride ions and the like, or nitrate ions or the like may be mentioned. The above mentioned counter-anions may be used individually or may be used in combinations of 2 or more.

The above described aqueous solution is prepared, for example, by dissolving a group 3 element compound which generates a group 3 element-containing cation upon dissolving, a group 4 element compound which generates a group 4 element-containing cation upon dissolving, and/or a group 5 element compound which generates a group 5 element-containing cation upon dissolving, in water or in an acidic aqueous solution. As the group 3 element compound, group 4 element compound, and group 5 element compound, for example, chlorides, oxychlorides, hydroxides, oxides, and nitrates may be mentioned, and from the point of being easily acquired and inexpensive, chlorides and oxychlorides are preferred. Further, in the point of ease of dissolving, nitrates are preferred. The forms of the above mentioned group 3 element compound, group 4 element compound, and group 5 element compound are not particularly limited, and for example, a solid such as a powder or the like, and an aqueous solution or the like may be mentioned. Each of the above mentioned group 3 element compound, group 4 element compound, and group 5 element compound may be used individually or may be used in combinations of two or more.

The aqueous solution obtained in the aqueous solution preparation step preferably has a pH of less than 7, namely, it is preferably acidic. The group 3 element-containing cations exhibit a high water solubility over a range from strongly acidic to weakly acidic, but the group 4 element-containing cation and the group 5 element-containing cation only exhibit a high water solubility in a strongly acidic range. Accordingly, the aqueous solution prepared in the aqueous solution preparation step is preferably strongly acidic (for example, a pH of 3 or less) from the viewpoint of stability.

### Simultaneous Precipitation Processing Step

In the simultaneous precipitation processing step, by mixing the aqueous solution obtained in the aqueous solution preparation step and a basic aqueous solution, an oxide and/or hydroxide of a group 3 element, and an oxide and/or hydroxide of a group 4 and/or group 5 element are precipitated and a precipitate is obtained. The method of mixing the aqueous solution obtained in the aqueous solution preparation step and the basic aqueous solution is not particularly limited, and for example, a method of dripping or spraying the aqueous solution obtained in the aqueous solution preparation step into the basic aqueous solution may be mentioned.

The pH of the basic aqueous solution is preferably 8 or more from the viewpoint of precipitation speed. The basic aqueous solution is not particularly limited, and for example, ammonia water, and a lithium hydroxide aqueous solution may be mentioned. From the point of ease of acquisition and the point of low cost, ammonia water is preferable. Further, from the viewpoint of preventing contamination of the solid electrolyte, a lithium hydroxide aqueous solution is preferable, of which the alkali cation is a lithium ion, namely, a cation constituting the solid electrolyte.

The mol equivalent of the base of the basic aqueous solution used in the simultaneous precipitation processing step is preferably greater compared to the mol equivalent of the counter-anions of the group 3 element-containing cation, the group 4 element-containing cation, and the group 5 element-containing cation (however, excluding oxide ions and hydroxide ions) in the aqueous solution obtained in the aqueous solution preparation step, and is more preferably a large excess (for example, on the order of two times or more). If the mol equivalent of the base of the basic aqueous solution is greater than the mole equivalent of the above mentioned counter-anions, it is easy to sufficiently maintain the basicity of the mixed solution even after mixing the aqueous solution obtained in the aqueous solution preparation step and the basic aqueous solution.

The precipitate obtained in the simultaneous precipitation processing step is appropriately separated and washed. The separation method is not particularly limited, and for example, centrifugation, decantation, filtration, and the like may be mentioned. Further, the solvent used in washing is not particularly limited, and from the point of ease of acquisition and the point of low cost, water is mentioned as a preferable example.

### Solid-Electrolyte Precursor Producing Step

In the solid-electrolyte precursor producing step, the precipitate obtained in the simultaneous precipitation processing step is mixed with a lithium compound to obtain a solid-electrolyte precursor. The method of mixing the above mentioned precipitate and the lithium compound is not particularly limited, and for example, a solid phase mixing method, liquid phase mixing method, gas phase mixing method (for example, deposition or the like) may be mentioned, and as a method for obtaining a solid-electrolyte precursor by the liquid phase mixing method, as described later, a method of carrying out hydrothermal treatment after mixing (hydrothermal method) or a sorbothermal method may be used. Because the control of the preparation ratio is easy, the solid phase mixing method or liquid phase mixing method are preferable.

The above mentioned lithium compound may be used individually or may be used in combinations of two or more. The lithium compound is not particularly limited, and for example, lithium carbonate, lithium chloride, lithium fluoride, lithium hydroxide, lithium nitrate, lithium acetate, and their hydrates may be mentioned. Further, the form of the lithium compound, for example, may be a solid such as a powder or the like, or may be an aqueous solution, and is not particularly limited. When synthesizing the solid electrolyte by low temperature firing, there are few components which are decomposed and eliminated, and the diffusion of lithium in the precipitate of the oxide and/or hydroxide of the group 3 element, and the oxide and/or hydroxide of the group 4 and/or group 5 element is sufficiently performed at a lower temperature than the firing temperature, therefore, it is preferable to use lithium hydroxide or a hydrate thereof with a low melting point of 462° C. in the form of a solid or an aqueous solution. However, if the lithium compound is fired at a temperature at the melting point or above in particular, there are cases where the lithium is readily volatilized, and in order to suppress this, lithium carbonate which has a melting point or decomposition temperature of 600° C. or more and which has relatively few components which are decomposed and eliminated by low temperature firing, may be used.

Further, in the above mentioned lithium compound, it is possible to use a complex of lithium and a constituent element of the solid-electrolyte precursor other than lithium. In particular, by using a complex oxide of lithium and a group 4 and/or group 5 element as the complex, the volatilization of lithium can be suppressed, while firing at a lower temperature (900° C. or less), whereby it is possible to obtain a solid electrolyte having a single-phase perovskite structure or a single-phase garnet structure, and therefore this is preferable. As such a complex oxide, for example, a lithium-titanium complex oxide (Li2TiO3, Li4Ti5O12, Li2Ti3O7 and the like), a lithium-zirconium complex oxide (Li3ZrO3, Li4ZrO4 and the like), lithium niobate (LiNbO3), lithium tantalate (LiTaO3), and the like may be mentioned. In order to lower the firing temperature of the solid electrolyte, it is necessary for the above mentioned precipitate and the complex oxide to be sufficiently mixed, and therefore, the complex oxide is preferably a fine particulate solid produced by a wet method or the like.

As the method for obtaining a solid-electrolyte precursor by the liquid phase mixing method, for example, a method of obtaining a slurry or solution comprising the solid-electrolyte precursor by dispersing or dissolving the above mentioned precipitate and lithium compound in a solvent and mixing; and further, a method of obtaining a solid-electrolyte precursor in a solid state, or in a solution or a slurry with a regulated viscosity and comprising the solid-electrolyte precursor, by drying and eliminating the solvent from the above mentioned slurry or solution; and further, a method of obtaining a slurry or solution comprising the solid-electrolyte precursor by dispersing in a dispersion medium, or dissolving in solution, the above mentioned solid-electrolyte precursor in a solid state, and the like may be mentioned. As the solvent or dispersion medium used in the liquid phase mixing method, for example, water may be mentioned.

As the method of obtaining the solid-electrolyte precursor by the liquid phase mixing method, a method of carrying out hydrothermal treatment after mixing (hydrothermal method) may also be mentioned as an example. It is possible to obtain a solid electrolyte having a single-phase perovskite structure or a single-phase garnet structure by firing at a lower temperature (900° C. or less) from a solid-electrolyte precursor obtained by the hydrothermal method, therefore this is preferable. The hydrothermal method refers to a compound synthesis method or crystal growing method carried out under the presence of hot water at high temperature and high pressure, and chemical reactions which do not occur under normal temperature and normal pressure in aqueous solutions may proceed. In the present invention, by adding an aqueous solution comprising lithium to a precipitate comprising an oxide and/or hydroxide of a group 3 element, and an oxide and/or hydroxide of a group 4 and/or group 5 element, and carrying out high temperature, high pressure treatment, it is possible to incorporate the lithium, which is water soluble at normal temperature and normal pressure, into the precipitate, and by separating this precipitate from the aqueous solution, the solid-electrolyte precursor is obtained. Further, in the hydrothermal method, water is used as the solvent, but similar results can also be expected from methods (for example, the sorbothermal method) using solvents other than water (for example, organic solvents or the like).

By making the aqueous solution when performing the hydrothermal method strongly alkaline, it is possible to incorporate the lithium into the precipitate obtained in the simultaneous precipitation processing step under milder treatment conditions. When using lithium hydroxide as the lithium source in the hydrothermal method, further alkaline components may also be added and used. However, there are cases where the added alkaline components are incorporated into the precipitate. Alkaline components having a cation which is larger than an ammonium ion, such as TMAH (tetramethylammonium hydroxide) or cesium hydroxide, are not readily incorporated into the precipitate, and allow the lithium incorporation by the hydrothermal method to proceed smoothly, and therefore are preferable.

As the method for obtaining the solid-electrolyte precursor by the solid phase mixing method, for example, a method of obtaining the solid-electrolyte precursor by mixing the above mentioned precipitate and lithium compound using a ball mill, a mortar or the like may be mentioned.

It is possible to form the solid-electrolyte precursor by at least the above aqueous solution preparation step, simultaneous precipitation processing step, and solid-electrolyte precursor producing step. Further, the obtained solid-electrolyte precursor may also be temporarily dispersed in a dispersion medium, and subjected to spray drying or granulation. Further, before carrying out the low temperature firing, a film consisting of the solid-electrolyte precursor may be formed by a method such as coating or the like. Furthermore, between the aqueous solution preparation step and the solid-electrolyte precursor production step, or before the produced solid-electrolyte precursor is fired, a compound for improving the properties of the solid electrolyte such as a sintering aid or the like may be added to the solid-electrolyte precursor or the raw materials thereof.

### Manufacturing Method of the Solid Electrolyte

According to the present invention, the method of manufacturing the solid electrolyte is one comprising a firing step of firing the solid-electrolyte precursor according to the present invention at a temperature of 1000° C. or less to obtain a solid electrolyte. By this manufacturing method, it is possible to synthesize a solid electrolyte comprising lithium, a group 3 element, and a group 4 and/or group 5 element and having a single-phase perovskite structure or a single-phase garnet structure. As specific examples of the solid electrolyte, those exemplified in the explanation of the solid-electrolyte precursor can be mentioned.

The firing method is not particularly limited, and for example, publicly known firing methods such as solid phase heat firing, spray drying, microwave firing and the like may be applied. The firing temperature is usually 1000° C. or less, and preferably 600° C. to 1000° C.

### Method of Manufacturing the Solid-Electrolyte/Electrode-Active-Material Complex

According to the present invention, the method of manufacturing the solid-electrolyte/electrode-active-material complex is one comprising a contacting step of contacting the solid-electrolyte precursor according to the present invention and an electrode active material or an electrode active material precursor which becomes an electrode active material by firing, and a firing step of firing the above mentioned solid-electrolyte precursor and the above mentioned electrode active material or the above mentioned electrode active material precursor at a temperature of 1000° C. or less to obtain a solid-electrolyte/electrode-active-material complex.

### Contacting Step

In the contacting step, the method of contacting the above mentioned solid-electrolyte precursor and the above mentioned electrode active material or the above mentioned electrode active material precursor is not particularly limited. For example, a method of mixing the above mentioned solid-electrolyte precursor and the above mentioned electrode active material or the above mentioned electrode active material precursor in the form of a powder, solution, or the like, or a method of contacting the surfaces of a molded body comprising the above mentioned solid-electrolyte precursor and a molded body comprising the above mentioned electrode active material or the above mentioned electrode active material precursor may be mentioned. Each of the above mentioned solid-electrolyte precursor, the above mentioned electrode active material, and the above mentioned electrode active material precursor may be used individually or may be used in combinations of two or more.

In the above mentioned electrode active material, as the negative active material, for example, carbon (graphite, hard carbon and the like) and its lithium compounds; metals which form alloys with lithium (magnesium, calcium, aluminum, silicon, germanium, tin, lead, bismuth, antimony, silver, zinc, and the like), and their lithium alloys; monoxides of transition metals such as cobalt, nickel, iron, titanium and the like; sulfides of transition metals such as cobalt, nickel, copper and the like; phosphides of transition metals such as nickel, iron, cobalt and the like; lithium nitride and lithium-transition metal complex nitrides; and metal oxides such as TiO2, Nb2O5, WO2, MoO2, Li4Ti5O12, Li2Ti3O7 and the like, may be mentioned.

In the above mentioned electrode active material precursor, as a negative electrode active material precursor which becomes a negative electrode active material by firing, for example, a simple element constituting the negative electrode active material and its oxide, hydroxide, chloride, carbonate, nitrate, or complex salt having an organic ligand or the like, may be mentioned.

In the above mentioned electrode active material, as a positive electrode active material, for example, LiMO2 complex oxides (where M is one or two or more metal atoms of Li, Al, Mn, Co, Ni or the like, and in the case that M is two or more metal atoms, the sum of their number is 1) having a lamellar rock-salt structure such as Li[Ni1/3Co1/3Mn1/3]O2 and the like;

LiM2O4 complex oxides (where M is one or two or more metal atoms of Li, Mn, Al, Ti, Ni or the like, and in the case that M is two or more metal atoms, the sum of their number is 2) having a spinel structure such as Li[Ni1/2Mn3/2]O4 and the like;

complex oxides comprising polyanions such as phosphates, polyphosphates, silicates, sulfates, borates and the like, such as LiMPO4, Li2MSiO4, Li2MPO4F (wherein M=Mn, Fe, Co, or Ni); vanadium oxide and lithium vanadium complex oxides; sulfur, sulfur-containing organic compounds, and metal chalcogenides such as MAx (M=Ti, V, Mo, or Nb, and A=S or Se) and the like, as well as their lithium compounds may be mentioned.

In the above mentioned electrode active material precursor, as a positive electrode active material precursor which becomes a positive electrode active material by firing, for example, a simple element constituting the positive electrode active material and its oxide, hydroxide, chloride, carbonate, nitrate, or complex salt having an organic ligand or the like, may be mentioned.

### Firing Step

In the firing step, firing is carried out in the same way as described above for the method of manufacturing the solid electrolyte. In this way, it is possible to obtain a solid-electrolyte/electrode-active-material complex. Further, from the viewpoint of suppressing decomposition of the electrode active material, the lower the firing temperature is, the more preferable it is, and a temperature of 900° C. or less (for example 600 to 900° C.) is more preferable.

### EXAMPLES

Below, examples and comparative examples are shown, and the present invention is specifically explained, but the present invention is not limited by these examples. Further, quality evaluation of the solid-electrolyte precursors and the solid electrolytes obtained using the same was carried out by the methods shown below.
(1) Total Content of Carbon and Nitrogen in the Solid-Electrolyte Precursor

The total content of carbon and nitrogen included in the solid-electrolyte precursor was measured by the oxygen circulation combustion-TCD measurement method.
(2) Mass Reduction Rate When Firing

The mass of the solid-electrolyte precursor before firing, and the mass of the solid electrolyte obtained after firing were measured, and the mass reduction rate was calculated from the following equation.

mass reduction rate (mass %)=(mass of solid-electrolyte precursor−mass of solid electrolyte)×100/mass of solid-electrolyte precursor
(3) Crystal Structure Analysis of the Solid Electrolyte

The crystal structure of the solid electrolyte was determined by powder X ray diffraction measurement.
(4) Presence or Absence of Cracking

The solid-electrolyte precursor was molded and firing was carried out by the procedures disclosed in each of the examples and comparative examples, and fired bodies of 13 mmφ and 0.5 mm thickness were produced. The surfaces of these fired bodies were observed by eye, and the presence or absence of cracking was confirmed.

### Example 1

A solution obtained by dissolving lanthanum hydroxide in hydrochloric acid was mixed with an aqueous solution of titanium tetrachloride, and an aqueous solution with an La concentration of 0.98 mmol/g, a Ti concentration of 1.75 mmol/g, and a Cl concentration of 7.50 mmol/g was prepared. This aqueous solution was transparent, and even when standing at room temperature, no precipitate was formed. 10 g of this aqueous solution was dripped in small amounts into 10 g of 28 mass % ammonia water and a precipitate was formed. Further, the amount of base was 164 mmol base equivalent (namely, the counter-anion of the group 3 element-containing cation, the group 4 element-containing cation, and the group 5 element-containing cation (however, excluding the oxide ions and hydroxide ions) is a chloride ion (75.0 mmol), and the above mentioned base equivalent corresponds to 2.19 times the mol equivalent of the counter-anion).

The precipitate was separated, washed with water, and after mechanical crushing, 0.21 g of lithium carbonate (2.8 mmol, or 5 6 mmol converted to lithium) was added, and kneaded using a mortar, and dried at 200° C. and a solid-electrolyte precursor in a solid state was obtained. The total content of carbon and nitrogen contained in this precursor was 2.2 mass %.

This precursor was fired for 5 hours at 950° C., and a fired body (solid electrolyte) was obtained. This fired body was crystalline, having a single-phase perovskite structure. Further, the mass reduction rate when firing was 26 mass %. The production conditions for the above mentioned solid-electrolyte precursor and the above mentioned fired body (solid electrolyte) are shown in Table 1, and the quality evaluation results are shown in Table 2.

### Example 2

A precipitate obtained by the same method as Example 1 was separated, washed with water, and after mechanical crushing, 1.12 mL of a 5N aqueous solution of lithium hydroxide (corresponding to 5 6 mmol of lithium hydroxide) was added, and water was added with stirring for 15 hours. After heat-concentrating, the solid portion was separated by centrifugation, dried at 200° C., and a solid-electrolyte precursor in a solid state was obtained. The total content of carbon and nitrogen contained in this precursor was 1.2 mass %.

This precursor was fired for 5 hours at 950° C., and a fired body (solid electrolyte) was obtained. This fired body was crystalline, having a single-phase perovskite structure. Further, the mass reduction rate when firing was 22 mass %. The production conditions for the above mentioned solid-electrolyte precursor and the above mentioned fired body (solid electrolyte) are shown in Table 1, and the quality evaluation results are shown in Table 2.

### Example 3

A precipitate obtained by the same method as Example 1 was separated, washed with water, and after mechanical crushing, was loaded into a pressure vessel, and 1.12 mL of a 5N aqueous solution of lithium hydroxide (corresponding to 5 6 mmol of lithium hydroxide) and 30 g of a 25 mass % aqueous solution of TMAH (tetramethylammonium hydroxide) were added. The above mentioned pressure vessel was sealed, and hydrothermal treatment was carried out by heating for 17 hours in an oil bath set at 180° C. After standing to cool, a precipitate was separated, washed with water, dried at 200° C., and a solid-electrolyte precursor in a solid state was obtained. The total content of carbon and nitrogen contained in this precursor was 0.8 mass %.

This precursor was fired for 12 hours at 850° C., and a fired body (solid electrolyte) was obtained. This fired body was crystalline, having a single-phase perovskite structure. Further, the mass reduction rate when firing was 8.9 mass %. The production conditions for the above mentioned solid-electrolyte precursor and the above mentioned fired body (solid electrolyte) are shown in Table 1, and the quality evaluation results are shown in Table 2.

### Example 4

A solid-electrolyte precursor in a solid state was obtained by the same method as in Example 3, except that, in the hydrothermal treatment, instead of 30 g of a 25 mass % TMAH (tetramethylammonium hydroxide) aqueous solution, 30 g of a 1.8 mmol/g cesium hydroxide aqueous solution was used. The total content of carbon and nitrogen contained in this precursor was 1.2 mass %.

This precursor was fired for 12 hours at 850° C., and a fired body (solid electrolyte) was obtained. This fired body was crystalline, having a single-phase perovskite structure. Further, the mass reduction rate when firing was 10.5 mass %. The production conditions for the above mentioned solid-electrolyte precursor and the above mentioned fired body (solid electrolyte) are shown in Table 1, and the quality evaluation results are shown in Table 2.

### Example 5

Lanthanum chloride 7 hydrate and zirconium oxychloride 8 hydrate were dissolved in cold water, and an aqueous solution with an La concentration of 0.83 mmol/g, a Zr concentration of 0.56 mmol/g, and a Cl concentration of 3.61 mmol/g was prepared. This aqueous solution was transparent, and even when standing at room temperature, no precipitate was formed. 10 g of this aqueous solution was sprayed into 25 ml of a 4N aqueous solution of lithium hydroxide and a precipitate was formed. Further, the base amount was 100 mmol base equivalent (namely, the counter-anion of the group 3 element-containing cation, the group 4 element-containing cation, and the group 5 element-containing cation (however, excluding the oxide ions and hydroxide ions) is a chloride ion (36.1 mmol), and the above mentioned base equivalent corresponds to 2.77 times the mol equivalent of the counter-anion).

The precipitate was separated, washed with water, and after drying at 200° C., 0.82 g of solid lithium hydroxide 1 hydrate (19.6 mmol) was added, ground with a mortar and mixed and a solid-electrolyte precursor in a solid state was obtained. The total content of carbon and nitrogen contained in this precursor was 4.2 mass %.

This precursor was fired for 9 hours at 700° C., and a fired body (solid electrolyte) was obtained. This fired body was crystalline, having a single-phase garnet structure. Further, the mass reduction rate when firing was 29 mass %. The production conditions for the above mentioned solid-electrolyte precursor and the above mentioned fired body (solid electrolyte) are shown in Table 1, and the quality evaluation results are shown in Table 2.

### Example 6

10 g of an aqueous solution prepared by the same method as Example 5 were sprayed into 10 g of 28 mass % ammonia water, and a precipitate was formed. Further, the amount of base was 164 mmol base equivalent (namely, the counter-anion of the group 3 element-containing cation, the group 4 element-containing cation, and the group 5 element-containing cation (however, excluding the oxide ions and hydroxide ions) is a chloride ion (36.1 mmol), and the above mentioned base equivalent corresponds to 4.54 times the mol equivalent of the counter-anion).

The precipitate was separated, washed with water, and after drying at 200° C., 0.72 g of solid lithium carbonate (9.8 mmol, or 19.6 mmol converted to lithium) was added, ground using a mortar and mixed and a solid-electrolyte precursor in a solid state was obtained. The total content of carbon and nitrogen contained in this precursor was 4.5 mass %.

This precursor was fired for 5 hours at 950° C., and a fired body (solid electrolyte) was obtained. This fired body was crystalline, having a single-phase garnet structure. Further, the mass reduction rate when firing was 36 mass %. The production conditions for the above mentioned solid-electrolyte precursor and the above mentioned fired body (solid electrolyte) are shown in Table 1, and the quality evaluation results are shown in Table 2.

### Example 7

### Formation of the Precipitate

A solution obtained by dissolving lanthanum chloride 7 hydrate in water was mixed with a titanium tetrachloride aqueous solution, and an aqueous solution with an La concentration of 0.98 mmol/g, a Ti concentration of 1.47 mmol/g, and a Cl concentration of 6.77 mmol/g was prepared. This aqueous solution was transparent, and even when standing at room temperature, no precipitate was formed.

50 g of this aqueous solution was dripped in small amounts into 50 g of 28 mass % ammonia water and a precipitate was formed. Further, the amount of base was 820 mmol base equivalent (namely, the counter-anion of the group 3 element-containing cation, the group 4 element-containing cation, and the group 5 element-containing cation (however, excluding the oxide ions and hydroxide ions) is a chloride ion (338.5 mmol), and the above mentioned base equivalent corresponds to 2.42 times the mol equivalent of the counter-anion). The precipitate was separated, washed with water, and mechanically crushed.

### Production of the Lithium-Titanium Complex Oxide

4.0 g of a titanium tetrachloride aqueous solution with a Ti concentration of 3.5 mmol/g and a Cl concentration of 9.1 mmol/g was dripped into 5.0 g of 28 mass % ammonia water, the formed solid was separated, washed with water, and after mechanical crushing, loaded into a pressure vessel, and 5.6 mL of a 5N aqueous solution of lithium hydroxide (corresponding to 28.0 mmol of lithium hydroxide) was added. The above mentioned pressure vessel was sealed, and hydrothermal treatment was carried out by heating for 15 hours in an oil bath set to 180° C. and by separating the solid portion, a lithium-titanium complex oxide in solid state was obtained.

### Production of the Solid-Electrolyte Precursor

The above mentioned precipitate and the above mentioned lithium-titanium complex oxide were kneaded using a planetary ball mill, and dried at 200° C. whereby a solid-electrolyte precursor in solid state was obtained. The total content of carbon and nitrogen contained in this precursor was 1.2 mass %.

### Production of the Solid Electrolyte

This precursor was fired for 12 hours at 850° C., and a fired body (solid electrolyte) was obtained. This fired body was crystalline, having a single-phase perovskite structure. Further, the mass reduction rate when firing was 16 mass %. The production conditions for the above mentioned solid-electrolyte precursor and the above mentioned fired body (solid electrolyte) are shown in Table 1, and the quality evaluation results are shown in Table 2.

### Comparative Example 1

Solid lanthanum hydroxide, lithium carbonate, and titanium dioxide were mixed in a mol ratio of La:Li:Ti=0.56:0.32:1, and after carrying out preliminary firing for 12 hours at 900° C., were again mixed by grinding in a mortar, and firing was carried out for 12 hours at 1050° C. The obtained fired body, in addition to the target perovskite phase, also included impurity phases such as lanthanum oxide, lithium titanate, lanthanum titanate, and the like, and a single phase perovskite structure could not be obtained. The production conditions for this fired body (solid electrolyte) are shown in Table 1, and the quality evaluation results are shown in Table 2.

### Comparative Example 2

Solid lanthanum hydroxide, lithium carbonate, and zirconium dioxide were mixed in a mol ratio of La:Li:Zr=3:7:2, and after carrying out preliminary firing for 12 hours at 900° C., were again mixed by grinding in a mortar, and firing was carried out for 12 hours at 1050° C. The obtained fired body, in addition to the target garnet phase, also included impurity phases such as lanthanum oxide, zirconium dioxide, lithium zirconate, and the like, and a single phase garnet structure could not be obtained. The production conditions for this fired body (solid electrolyte) are shown in Table 1, and the quality evaluation results are shown in Table 2.

### Comparative Example 3

Lithium acetate, lanthanum acetate 1.5 hydrate, and a titanium lactate aqueous solution containing 5 mass % titanium were mixed, and an aqueous solution (sol) with an Li concentration of 0.14 mmol/g, La concentration of 0.25 mmol/g, and Ti concentration of 0.44 mmol/g was prepared. This aqueous solution was a transparent yellow, and even when standing at room temperature, no precipitate was observed. 10 g of this aqueous solution were heat-concentrated with stirring for 8 hours at 120° C., and further moved to an oven and dried at 200° C. to obtain a solid-electrolyte precursor (gel) in a solid state. The total content of carbon and nitrogen contained in this precursor was 32 mass %.

This precursor was fired for 5 hours at 950° C., and a fired body (solid electrolyte) was obtained. This fired body was crystalline, having a single-phase perovskite structure. Further, the mass reduction rate when firing was 68 mass %. The production conditions for the above mentioned solid-electrolyte precursor and the above mentioned fired body (solid electrolyte) are shown in Table 1, and the quality evaluation results are shown in Table 2.

### Comparative Example 4

Lithium nitrate, lanthanum nitrate 6 hydrate, a zirconium propoxide solution (solvent: 1-propanol) containing 72.5 mass % zirconium, and a mixture of ethanol and ethyl acetoacetate (mol ratio 50:1.6) were mixed, and a solution (sol) with an Li concentration of 1.47 mmol/g, an La concentration of 0.57 mmol/g, and a Zr concentration of 0.39 mmol/g was prepared. After 20 g of this solution were heated for 12 hours at 80° C. with stirring, heat-concentration was carried out for 5 hours at 150° C. This was further moved to an oven and dried at 200° C. to obtain a solid-electrolyte precursor (gel) in a solid state. The total content of carbon and nitrogen contained in this precursor was 11.5 mass %.

This precursor was fired for 5 hours at 950° C., and a fired body (solid electrolyte) was obtained. This fired body, in addition to the target garnet phase, also included impurity phases such as lanthanum oxide, lanthanum hydroxide and the like, and a single phase garnet structure could not be obtained. Further, the mass reduction rate when firing was 47 mass %. The production conditions for the above mentioned solid-electrolyte precursor and the above mentioned fired body (solid electrolyte) are shown in Table 1, and the quality evaluation results are shown in Table 2.

TABLE 1

| | | |
|---|---|---|
| | Basic aqueous | |
| | solution used | Lithium compound |
| Aqueous solution for producing | in simultaneous | used in |
| solid-electrolyte precursor *1 | precipitation | solid-electrolyte |

| | | | |
|---|---|---|---|
| | Counter-anion | processing | precursor |
| Group 4 | (excluding | step *2 | producing |

| | | | | |
|---|---|---|---|---|
| and/or | oxide ions and | Base | step | Temper- |

| | Group 3 | | group 5 | | hydroxide ions) | | | amount | | Added | | ature |
|---|---|---|---|---|---|---|---|---|---|---|---|---|
| | element | | element | | Type | | | [mmol | | amount | | of firing |
| | | Content | | Content | (ele- | Content | | base | | [mmol | Mixing | step |
| | Type | [mmol] | Type | [mmol] | ment) | [mmol] | Type | equivalent] *3 | Type | Li] | method | [° C.] |
| Example 1 | La | 9.8 | Ti | 17.5 | Cl | 75.0 | ammonia | 164 | lithium | 5.6 | solid phase | 950 |
| | | | | | | | water | | carbonate | | mixing | |
| Example 2 | La | 9.8 | Ti | 17.5 | Cl | 75.0 | ammonia | 164 | lithium hydroxide | 5.6 | liquid phase | 950 |
| | | | | | | | water | | aqueous solution | | mixing | |
| Example 3 | La | 9.8 | Ti | 17.5 | Cl | 75.0 | ammonia | 164 | lithium hydroxide | 5.6 | hydrothermal | 850 |
| | | | | | | | water | | aqueous solution | | method | |
| Example 4 | La | 9.8 | Ti | 17.5 | Cl | 75.0 | ammonia | 164 | lithium hydroxide | 5.6 | hydrothermal | 850 |
| | | | | | | | water | | aqueous solution | | method | |
| Example 5 | La | 8.3 | Zr | 5.6 | Cl | 36.1 | lithium | 100 | lithium hydroxide | 19.6 | solid phase | 700 |
| | | | | | | | hydroxide | | 1 hydrate | | mixing | |
| | | | | | | | aqueous | | | | | |
| | | | | | | | solution | | | | | |
| Example 6 | La | 8.3 | Zr | 5.6 | Cl | 36.1 | ammonia | 164 | lithium carbonate | 19.6 | solid phase | 950 |
| | | | | | | | water | | | | mixing | |
| Example 7 | La | 49.0 | Ti | 73.5 | Cl | 338.5 | ammonia | 820 | lithium-titanium | 28.0 | solid phase | 850 |
| | | | | (87.5) *4 | | | water | | complex oxide | | mixing | |

| | |
|---|---|
| Comparative | Preparation of sample by solid phase method by carrying out mixing of solid lanthanum hydroxide, lithium carbonate, |
| Example 1 | and titanium dioxide, preliminary firing at 900° C., and firing for 12 hours at 1050° C. |
| Comparative | Preparation of sample by solid phase method by carrying out mixing of solid lanthanum hydroxide, lithium carbonate, |
| Example 2 | and zirconium dioxide, preliminary firing at 900° C., and firing for 12 hours at 1050° C. |
| Comparative | Preparation of sample by sol-gel method by carrying out drying of an aqueous solution of lithium acetate, lanthanum |
| Example 3 | acetate, and titanium lactate at 200° C., and firing at 950° C. |
| Comparative | Preparation of sample by sol-gel method by carrying out drying of an ethanol/ethyl acetoacetate solution comprising |
| Example 4 | lithium nitrate, lanthanum nitrate and zirconium propoxide at 200° C., and firing at 950° C. |

*1: The pH of the aqueous solution for producing the precursor was approximately 2 or lower.
*2: The basic aqueous solution used in the simultaneous precipitation processing step is strongly basic, and at the point in time that the simultaneous precipitation processing is completed, the mixed solution was basic (lanthanum hydroxide precipitates in neutral to basic conditions).
*3: The mol equivalent of the base of the basic aqueous solution is greater than the mol equivalent of the counter-anions of the group 3 element-containing cation, the group 4 element-containing cation, and the group 5 element-containing cation (however, excluding oxide ions and hydroxide ions) in the aqueous solution for producing the precursor.
*4: The amount added to the system in the simultaneous precipitation processing step is 73.5 mmol. Because 14.0 mmol are included in the lithium-titanium complex oxide which is the lithium compound, a total of 87.5 mmol is included in the precursor.

TABLE 2

| | Total | | | |
|---|---|---|---|---|
| | content of | | | |
| | carbon | | | |
| | and | | | |
| | nitrogen | Mass | | |
| | in the | reduction | | Presence |
| | solid- | rate | Crystal | or |
| | electrolyte | when | structure | absence |
| | precursor | firing | of the | of |
| | [Mass %] | [Mass %] | fired body | cracking |
| Example | 2.2 | 26 | single phase | absent |
| 1 | | | perovskite structure | |
| Example | 1.2 | 22 | single phase | absent |
| 2 | | | perovskite structure | |
| Example | 0.8 | 8.9 | single phase | absent |
| 3 | | | perovskite structure | |
| Example | 1.2 | 10.5 | single phase | absent |
| 4 | | | perovskite structure | |
| Example | 4.2 | 29 | single phase | absent |
| 5 | | | garnet structure | |
| Example | 4.5 | 36 | single phase | absent |
| 6 | | | garnet structure | |
| Example | 1.2 | 16 | single phase | absent |
| 7 | | | perovskite structure | |
| Compar- | 1.0 | 11 | includes impurity | — |
| ative | | | phases other than | |
| Example 1 | | | perovskite phase | |
| Compar- | 3.9 | 22 | includes impurity | — |
| ative | | | phases other than | |
| Example 2 | | | garnet phase | |
| Compar- | 32 | 68 | single phase | present |
| ative | | | perovskite structure | |
| Example 3 | | | | |
| Compar- | 11.5 | 47 | includes impurity | present |
| ative | | | phases other than | |
| Example 4 | | | garnet phase | |

As can be understood from Tables 1 and 2, in the solid-electrolyte precursors of the examples prepared by going through the simultaneous precipitation processing step, the total content of carbon and nitrogen was 10 mass % or less. The mass reduction rate when firing this solid-electrolyte precursor was 40 mass % or less. Also, the crystal structure of the obtained solid electrolyte was a single phase perovskite structure or a single phase garnet structure. Further, cracking was not observed at the surfaces of the fired bodies obtained by molding the above mentioned solid-electrolyte precursors.

In contrast, in Comparative Examples 1 and 2 which used the solid phase method, the firing temperature in order to obtain the solid electrolyte exceeded 1000° C. Further, the obtained solid electrolyte included impurity phases, and a single phase perovskite structure or a single phase garnet structure could not be obtained.

In the solid-electrolyte precursors of Comparative Examples 3 and 4 prepared using the sol-gel method, the total content of carbon and nitrogen exceeded 10 mass %. The mass reduction rate when firing these solid-electrolyte precursors exceeded 40 mass %. Further, while in Comparative Example 3 a solid electrolyte having a single phase perovskite structure could be obtained, in Comparative Example 4, a single phase garnet structure could not be obtained. Further, cracking was observed at the surfaces of the fired bodies obtained by molding the above mentioned solid-electrolyte precursors.

In the claims:

1. A solid-electrolyte precursor for synthesis, by firing at a temperature of 1000° C. or less, of a solid electrolyte which comprises lithium, a group 3 element, and a group 4 and/or group 5 element and which has a single phase perovskite structure or a single phase garnet structure; the solid-electrolyte precursor comprising:
lithium, an oxide and/or hydroxide of a group 3 element, and an oxide and/or hydroxide of a group 4 and/or group 5 element.

2. The solid-electrolyte precursor according to claim 1, wherein a total content of carbon and nitrogen in the solid-electrolyte precursor is 10 mass % or less.

3. The solid-electrolyte precursor according to claim 1 or 2, wherein when obtaining the solid electrolyte by firing the solid-electrolyte precursor at a temperature of 1000° C. or less, a mass reduction rate calculated according to the formula below
mass reduction rate (mass %)=(mass of the solid-electrolyte precursor−mass of the solid electrolyte)×100/mass of the solid-electrolyte precursor
is 40 mass % or less.

4. The solid-electrolyte precursor according to claim 1, wherein the group 3 element is at least one element selected from the group consisting of yttrium, lanthanum, cerium, praseodymium, neodymium, samarium, europium, and gadolinium, and the group 4 and/or group 5 element is at least one element selected from the group consisting of titanium, zirconium, vanadium, niobium, and tantalum.

5. A method of manufacturing a solid electrolyte, comprising a firing step of obtaining a solid electrolyte by firing the solid-electrolyte precursor according to claim 1 at a temperature of 1000° C. or less.

6. A method of manufacturing a solid-electrolyte/electrode-active-material complex comprising a contacting step of contacting the solid-electrolyte precursor according to claim 1, and an electrode active material or an electrode active material precursor which becomes an electrode active material by firing, and a firing step of obtaining a solid-electrolyte/electrode-active-material complex by firing the solid-electrolyte precursor and the electrode active material or the electrode active material precursor at a temperature of 1000° C. or less.

7. A method of manufacturing a solid-electrolyte precursor for synthesis, by firing at a temperature of 1000° C. or less, of a solid electrolyte which comprises lithium, a group 3 element, and a group 4 and/or a group 5 element and which has a single phase perovskite structure or a single phase garnet structure; the method comprising:
an aqueous solution preparation step of preparing an aqueous solution comprising a group 3 element-containing cation, and a group 4 element-containing cation and/or a group 5 element-containing cation,
a simultaneous precipitation processing step of obtaining a precipitate by mixing the aqueous solution obtained in the aqueous solution preparation step and a basic aqueous solution to precipitate an oxide and/or hydroxide of the group 3 element, and an oxide and/or hydroxide of the group 4 and/or a group 5 element, and
a solid-electrolyte precursor producing step of obtaining a solid-electrolyte precursor by mixing the precipitate obtained in the simultaneous precipitation processing step and a lithium compound.

8. The method of manufacturing a solid-electrolyte precursor according to claim 7, wherein a total content of carbon and nitrogen in the solid-electrolyte precursor is 10 mass % or less.

9. The method of manufacturing a solid-electrolyte precursor according to claim 7, wherein a mol equivalent of a base of the basic aqueous solution used in the simultaneous precipitation processing step is greater than a mol equivalent of a counter-anion of the group 3 element-containing cation, the group 4 element-containing cation and the group 5 element-containing cation in the aqueous solution obtained in the aqueous solution preparation step (however, excluding oxide ions and hydroxide ions).

10. The method of manufacturing a solid-electrolyte precursor according to claim 7, wherein a pH of the aqueous solution obtained in the aqueous solution preparation step is less than 7, and a pH of the basic aqueous solution used in the simultaneous precipitation processing step is 8 or more.

11. The method of manufacturing a solid-electrolyte precursor according to claim 7, wherein, in the solid-electrolyte precursor producing step, the lithium compound mixed with the precipitate is a complex of lithium and an element other than lithium, the element constituting the solid-electrolyte precursor.

12. The method of manufacturing a solid-electrolyte precursor according to claim 7, wherein, in the solid-electrolyte precursor producing step, a mixture comprising the precipitate, the lithium compound, and a solvent is heated under a pressure higher than 1 atm.

13. A method of manufacturing a solid electrolyte comprising:
an aqueous solution preparation step of preparing an aqueous solution comprising a group 3 element-containing cation, and a group 4 element-containing cation and/or a group 5 element-containing cation,
a simultaneous precipitation processing step of obtaining a precipitate by mixing the aqueous solution obtained in the aqueous solution preparation step and a basic aqueous solution to precipitate an oxide and/or hydroxide of a group 3 element, and an oxide and/or hydroxide of a group 4 and/or a group 5 element,
a solid-electrolyte precursor producing step of obtaining a solid-electrolyte precursor by mixing the precipitate obtained in the simultaneous precipitation processing step and a lithium compound, and
a firing step of obtaining a solid electrolyte by firing the solid-electrolyte precursor obtained in the solid-electrolyte precursor producing step at a temperature of 1000° C. or less.

14. A method of manufacturing a solid-electrolyte/electrode-active-material complex comprising:
an aqueous solution preparation step of preparing an aqueous solution comprising a group 3 element-containing cation, and a group 4 element-containing cation and/or a group 5 element-containing cation,
a simultaneous precipitation processing step of obtaining a precipitate by mixing the aqueous solution obtained in the aqueous solution preparation step and a basic aqueous solution to precipitate an oxide and/or hydroxide of a group 3 element, and an oxide and/or hydroxide of a group 4 and/or a group 5 element,
a solid-electrolyte precursor producing step of obtaining a solid-electrolyte precursor by mixing the precipitate obtained in the simultaneous precipitation processing step and a lithium compound,
a contacting step of contacting the solid-electrolyte precursor obtained in the solid-electrolyte precursor producing step and an electrode active material or an electrode active material precursor which becomes an electrode active material by firing, and
a firing step of obtaining a solid-electrolyte/electrode-active-material complex by firing the solid-electrolyte precursor and the electrode active material or the electrode active material precursor at a temperature of 1000° C. or less.
